(19) United States
(12) Patent Application Publication
(10) Pub. No.: US 2014/0102263 A1
(43) Pub. Date: Apr. 17, 2014

(54) Lever Handle Extension

(71) Applicant: Leonard Francis Reichlin, Everett, WA (US)

(72) Inventor: Leonard Francis Reichlin, Everett, WA (US)

(21) Appl. No.: 14/098,856

(22) Filed: Dec. 6, 2013

(51) Int. Cl. B25G 1/04

(52) U.S. Cl. CPC B25G 1/043
USPC 81/177.2

(57) ABSTRACT

A torque amplifying lever extension providing a safe means of increasing the force applied to the handle of a wrench, other hand tool, or machine lever. A lever extension can be placed over virtually any size lever handle without adjustment of the lever extension. Using only one hand, a user can quickly add the lever extension to a lever handle and apply additional force with reduced risk of a tool or handle or the lever extension slipping and injuring the user or damaging the work.

### CROSS-REFERENCE TO RELATED APPLICATIONS

None.

### FEDERALLY SPONSORED RESEARCH

Not applicable

### SEQUENCE LISTING

Not applicable

### BACKGROUND

This invention relates to a hand tool generally, and to a lever handle extension specifically. This invention can increase the torque applied through the handle of many different kinds of levers. Pipes are discussed below but handles exist on many types of machinery and equipment. A pipe wrench handle is just one example of a tool or machine requiring the user to apply lever force to operate.

In most cases, threaded piping holds liquids or gasses under pressure. Pipe junctions and fittings have tapered threads that seal the joints against leakage. An interference fit is required to ensure a good seal. Frequently a pipe or fitting may require more force to loosen because of rust or pipe sealant. A pipe union has a pressure fit between the male and female ends. This requires greater force to tighten or loosen than other fittings of the same thread diameter.

The leverage that most users can apply is appropriate for the work the tool is designed for. However some situations require greater torque than the lever handle length will afford. The obvious solution then would be to use a bigger/longer wrench. However sometimes wrench jaws on the longer wrench will not fit the application. Workers then often resort to improvised methods. Commonly, a so called “cheater bar” made from a section of pipe is placed over the lever handle to extend the length of the lever arm. This can be awkward and dangerous. The improvised extension is difficult to grip. It can easily slip and damage the work or inflict injury to the worker or others.

Previous attempts to enhance lever handle torque have been made. U.S. Pat. No. 1,643,027 to Morgan, U.S. Pat. No. 6,308,596 B1 to Williams, U.S. Pat. No. 5,535,649 to Waggle, and U.S. Pat. No. 4,960,014 to Kelly describe a common implementation; a solid metal extension bar with brackets attached to cradle a wrench. Some designs include a means to fasten the extension on the wrench handle so the extension cannot slip while using the wrench. This design works well on typical flat mechanic's wrenches. It cannot safely cradle the wider, tapered handle of other tools such as a typical pipe wrench. It also adds significantly to the weight of the wrench.

Additionally, patents U.S. Pat. No. 6,761,094 to Tobako, U.S. Pat. No. 6,626,069 to Cooper and U.S. Pat. No.5,570,617 to Love are examples of sliding extensions designed to be integral with a tool handle. None of these designs will work on the tapered handle of almost any commercially available pipe wrench.

### SUMMARY OF THE INVENTION

My invention is directed at providing a strong, lightweight lever handle extension usable on a wide variety of currently available hand tools and on other machine levers.

The tapered shape of the lever extension will accommodate various size wrenches and other tools or levers with no adjustment to the lever extension. It will capture the lever handle within the body of the lever extension to reduce the chance of the lever extension slipping on the lever and causing injury. It can be used to turn control levers on many types of machinery when extra force is helpful. It will include a hand grip with an anti-slip surface to safely apply extra leverage.

An additional feature of the lever extension is its ability to isolate the user from extreme temperatures and vibration in the lever it extends.

### BRIEF DESCRIPTION OF THE DRAWINGS

FIG. 1 is a side view of the lever extension. It illustrates the cylindrical tapered body which allows most wrenches to align at the center of the lever extension and keeps the wrench from inserting too far into the lever extension. It also shows a typical pipe wrench inserted into the lever extension. Note that the lever extension opening is large enough to insert a variety of different size handles. The pipe wrench handle in FIG. 1 represents the handle of any machine or tool.

REFERENCE NUMERALS

10 lever extension

12 tapered intermediate section

14 open end

16 cylindrical body

18 end knob

20 hand grip

22 tool (representing any lever handle)

### DETAILED DESCRIPTION

The preferred embodiment of the invention is a tube drawn from a cylindrical blank of aircraft aluminum using impact extrusion. A hydraulic press is then used to uniformly stretch the blank to the shape of the lever extension 10. Said lever extension 10 includes a cylindrical body 16, a tapered intermediate section 12, a hand grip 20, and an aluminum end knob 18.

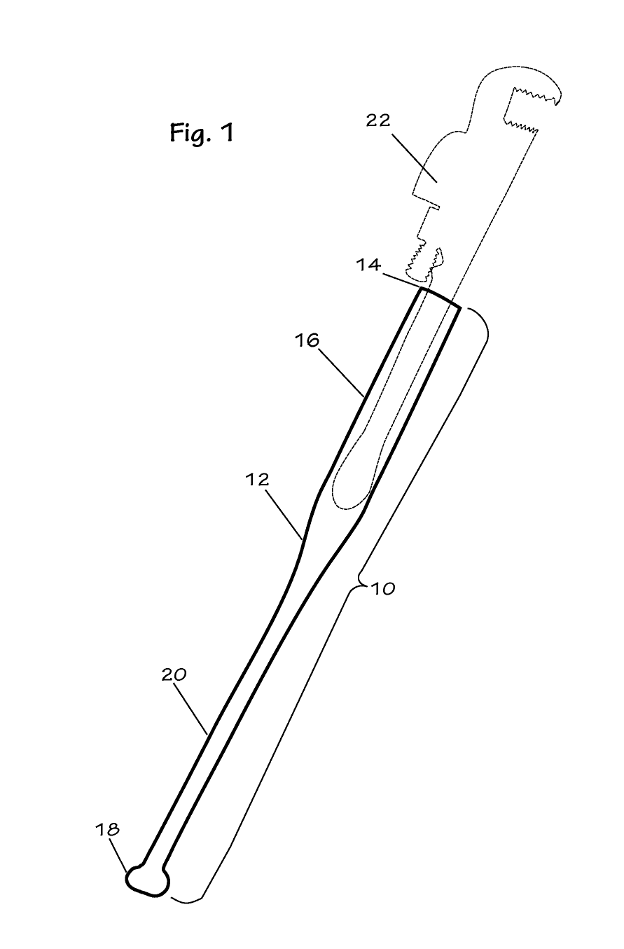

FIG. 1 is a side-view of said lever extension 10 illustrating an example tool 22, represented by dashed lines, to represent a lever positioned within the open end 16 of said lever extension 10. Said cylindrical body 16 of said lever extension 10 is large enough to accommodate a variety of handles of many sizes and shapes through said open end 14 of said lever extension 10.

Said hand grip 20 has a reduced diameter for effective gripping. Non-slip material may be applied to said hand grip 20 to further reduce the possibility of the user's hand accidentally slipping.

Said aluminum knob 18 is welded to the end of said hand grip 20 to keep the user's hand from slipping off said hand grip 20 when exerting force with said lever extension 10. Said aluminum knob 18 may be formed by machining, pressing, rolling or extruding.

An alternative embodiment of the invention can be constructed by simply removing the distal portion of a commercially available aluminum baseball bat to create said lever extension 10 with said open end 14.

### Operation

In operation the user simply slides said lever handle extension 10 over the handle of said tool or machine lever 22 until it bottoms in the tapered intermediate section 12 of said lever handle extension 10. The lever or tool handle 22 can be operated with one hand while using the other hand to brace the work or the user's body. Two lever handle extensions can be used in opposition when tightening or loosening pipes.

I claim:

1. A device to temporarily extend the length of a lever handle, an improvement wherein said lever handle is held within a lever extension comprising:
a. a hollow cylindrical body with an opening at the distal end of said lever extension and
b. a hand grip at the proximal end of said lever extension
whereby a user can amplify torque applied to a lever handle.

2. The lever extension in claim 1 wherein said cylindrical body and said hand grip are joined by a tapered intermediate section.

3. The lever extension in claim 2 wherein said hand grip has an anti-slip surface.

4. The lever extension in claim 2 wherein said hand grip terminates in a knob to keep a user's hand from sliding off said hand grip.

5. A new use for a hollow aluminum baseball bat manufactured with an opening in the distal end, an improvement wherein said baseball bat comprises:
a. a hollow cylindrical body with an opening at said distal end of said baseball bat and
b. a hand grip at said proximal end of said baseball bat
whereby a user can amplify torque applied to a lever handle.

6. A new use for a hollow aluminum baseball bat with the distal tip cut off, an improvement wherein said baseball bat comprises:
a. a hollow cylindrical body with an opening at said distal end of said baseball bat and
b. a hand grip at the proximal end of said baseball bat
whereby a user can amplify torque applied to a lever handle.
